(19) United States
(12) Patent Application Publication
(10) Pub. No.: US 2008/0107447 A1
(43) Pub. Date: May 8, 2008

(54) SYSTEMS AND METHODS FOR CYCLING LIGHT EMITTING DEVICES IN AN IMAGE-FORMING DEVICE

(75) Inventor: James William PATTERSON, Newark, NY (US)

Correspondence Address: OLIFF & BERRIDGE, PLC., P.O. BOX 320850, ALEXANDRIA, VA, 22320-4850, US

(73) Assignee: XEROX CORPORATION, Stamford, CT (US)

(21) Appl. No.: 11/555,839

(22) Filed: Nov. 2, 2006

(51) Int. Cl. G03G 21/00

(52) U.S. Cl. 399/128

(57) ABSTRACT

Systems and methods for discharging an electrostatic charge of a surface of a photoreceptor unit including at least one photoreceptor unit with a photoconductive surface and a charging unit that may electrostatically charge the photoconductive surface. At least one light emitting device is directed to the photoconductive surface. Control circuitry may be operatively connected to the at least one light emitting device. Further, the control circuitry may be configured to selectively activate the light emitting device to discharge portions of electrostatic charge on the photoconductive surface during an image forming cycle, and activate the at least one light emitting device during a non-image forming cycle to discharge electrostatic charge on the photoconductive surface.

### BACKGROUND

This disclosure is directed to systems and methods for improved discharging of residual electrostatic charges present in image-forming devices. In various exemplary embodiments, the systems and methods according to this disclosure are directed to cycling light emitting devices such as, for example, light emitting diode (LED) bar systems, and methods for controlling those systems in which a light emitting device is usable to discharge residual electrostatic charges in image-forming devices such as, for example, those present on photoreceptor surfaces.

Typically, in electrostatic image-forming devices, a latent image charge pattern is formed on a charge-receptive, photo-conductive member possessing dielectric characteristics. In general, a photoreceptor device such as, for example, a belt or a dram, is exposed to light from a laser unit, bark of light-emitting diodes, or other such light source to form the latent image on the photoreceptor unit. Pigmented volumes of marking particles are electrostatically attracted to the latent image charge pattern and develop, for example, a single- or multi-color toner image on the photoreceptor unit.

A receiving substrate such as, for example, a sheet of paper, or other such receiving medium, is brought into contact with the photoreceptor unit. An electrostatic field may be applied to the receiving substrate to transfer the toner image to the recording medium from the photoreceptor unit. Once the toner image is transferred to the receiving medium, differing methodologies are employed to “fix”, by heat and pressure, or otherwise “fuse,” the toner image to the receiving medium to produce a permanent image upon the receiver.

The photoreceptive unit is thus exposed to radiation in a pattern corresponding to a scanned image, forming the latent image charge pattern. When the exposure of the photoreceptor unit is accomplished electronically using a light-emitting device, such as an LED array, the light-emitting device may be activated according to appropriate electrical signals to bias the uniform charge on the dielectric surface of the photoreceptor unit to form a desired image-wise charge pattern. Individual diodes in the LED array generate light energy that passes, for example, through a fiber optic lens assembly onto the surface of the moving photoreceptor unit with sufficient intensity to locally discharge the surface of the photoreceptor unit and to establish a charge pattern on the photo-conductive surface that models a desired visual image pattern.

In such systems, individual LEDs may be linearly or in-plane arrayed as a bar unit device, or otherwise arranged in an array, to increase output power and to simplify the design of the image-forming device. An LED bar system may be arrayed, for example, to promote good optical alignment, and to simplify design to minimize the overall assembly.

The individual LEDs are typically arranged in such a bar system so that each individual LED produces an individual exposed pixel on the moving photoreceptor unit. The photoreceptor unit advances in the process direction to provide an image by the formation of successive scan lines.

Several LED bar systems may be positioned adjacent to a photoreceptor unit surface and may be individually energized to create consecutive energy exposures on the photoreceptor unit in the image-forming device. An LED bar system typically is supported by, or includes, digital circuitry, often requiring one or more clocks to synchronize the process. Individual LEDs in the bar system are turned on or not turned on in response to signals corresponding to a digital image via such digital circuitry. The digital signal processed by the clock allows for precise timing of activating individual LEDs of the array to establish a charge pattern on a moving photoreceptor unit, such that the electrostatically formed latent image is identical to the digital image.

After the latent image is formed on the photoreceptor unit, the latent image is brought into contact with a toner provider to form the toner image. The toner image is then transferred from the photoreceptor unit surface to the receiving medium such as, for example, paper. The transfer of the toner image from the photoreceptor unit to the receiving medium is rarely complete. In other words, residual toner remain adhered electrostatically to the surface of the photoreceptor unit. Many methodologies are conventionally employed to provide a capability whereby after transferring the toner image, any non-transferred toner particles are removed from the photoreceptor unit surface. Common among such methodologies is use of some sort of cleaning and/or wiper blade that physically scrapes residual toner particles from the surface of the photoreceptor unit. The photoreceptor unit surface is then discharged, often by a discharge lamp, before beginning the next image-forming cycle.

### SUMMARY

However, such a discharging lamp is not always effective in discharging all of the electrostatic charge left on the photoreceptor. This can result from numerous causes such as, for example, failure of the discharge lamp. Such failure results in a number of undesirable consequences such as, for example, excessive toner usage, excessive developer bead carry out, catastrophic developer dumping, and system failure.

It would be advantageous, therefore, to provide systems and methods by which residual toner particles remaining on the surface of the photoreceptor unit, and/or residual charge may be more effectively discharged.

In various exemplary embodiments according to this disclosure, a typical electrostatic image-forming device including one or more electrostatically charged photoreceptor units may be provided with an improved erase function to discharge residual electrostatic charge such as, for example, a latent photostatic image.

In various exemplary embodiments, systems and methods according to this disclosure provide improved capability for removing residual charges from a photoreceptor unit during a “cycle out” or non-image forming cycle that may occur based on either ineffective, or otherwise defective, erase function capability in a development zone.

Exemplary embodiments of the disclosed systems and methods may employ at least one photoreceptor unit with a photoconductive surface and a charging unit that electrostatically charges the photoconductive surface. At least one light emitting device may be directed to the photoconductive surface. Control circuitry, operatively connected to the light emitting device, selectively activates the at least one light emitting device to discharge portions of the electrostatic charge during an image forming cycle and activates the at least one light emitting device during a non-image forming cycle to discharge electrostatic charge. The electrostatic charge includes a latent photostatic image and/or residual charge left over from an ineffective, or otherwise defective, erase function.

In accordance with exemplary embodiments of the disclosure, the at least one light emitting device may comprise an LED array.

In accordance with exemplary embodiments of the disclosure, the at least one light emitting device may comprise at least two light emitting devices.

In accordance with exemplary embodiments of the disclosure, the at least two light emitting devices may be activated at different times during a single non-image forming cycle.

In accordance with exemplary embodiments of the disclosure, only one of the at least two light emitting devices may be activated during a single non-image forming cycle.

In accordance with exemplary embodiments of the disclosure, the non-image forming cycle may be immediately prior to the image forming cycle.

In accordance with exemplary embodiments of the disclosure, the non-image forming cycle may be immediately after the image forming cycle.

In accordance with exemplary embodiments of the disclosure, the at least one light emitting device may be routinely activated at a predetermined level during the non-image forming cycle.

In accordance with exemplary embodiments of the disclosure, the at least one light emitting device may be routinely activated for a defined time period during the non-image forming cycle.

In accordance with exemplary embodiments of the disclosure, a computer program product may be provided for enabling a computer to control a light emitting device in an electrostatic image forming device to be used as a photoreceptor surface discharger. The product may comprise software instructions that enables the computer to perform predetermined operations, and a computer readable medium bearing the software instructions. The predetermined operations may include: applying an electrostatic charge to a photoconductive surface; forming a latent image on the photoconductive surface by discharging portions of electrostatic charge on the photoconductive surface by selectively activating at least one light emitting device during a image forming cycle; and activating the at least one light emitting device during a non-imaging forming cycle to discharge electrostatic charge on the photoconductive surface,

These and other objects, advantages and features of the systems and methods according to this disclosure are described and, or apparent from, the following description of exemplary embodiments.

### BRIEF DESCRIPTION OF THE DRAWINGS

Various exemplary embodiments of disclosed systems and methods will be described, in detail, with reference to the following figures, wherein:

FIG. 1 illustrates a schematic side elevation view of a transfer subsystem for an electrostatic image forming device including a light emitting device used to discharge electrostatic charge on a photoreceptor surface;

FIG. 2 is a schematic block diagram of an exemplary system for implementing a method to remove residual charges from a photoreceptor unit during a non-image forming cycle; and

FIG. 3 is a flowchart outlining an exemplary method for removing residual charges from a photoreceptor unit during a non-image forming cycle.

### DETAILED DESCRIPTION OF EMBODIMENTS

The following description of various exemplary systems and methods for removing residual charges from a photoreceptor unit during a “cycle out” or non-image forming cycle for in an electrostatic image forming devices may refer to and/or illustrate a specific type of electrostatic image forming device, a xerographic imaging system, for the sake of clarity, familiarity, and ease of depiction and description. However, it should be appreciated that the principles disclosed herein, as outlined and/or discussed below, can be equally applied to any known, or later-developed, system in which, prior to, during or after, electrostatic image forming it is desirable to discharge an electrostatic charge of a photoreceptor unit.

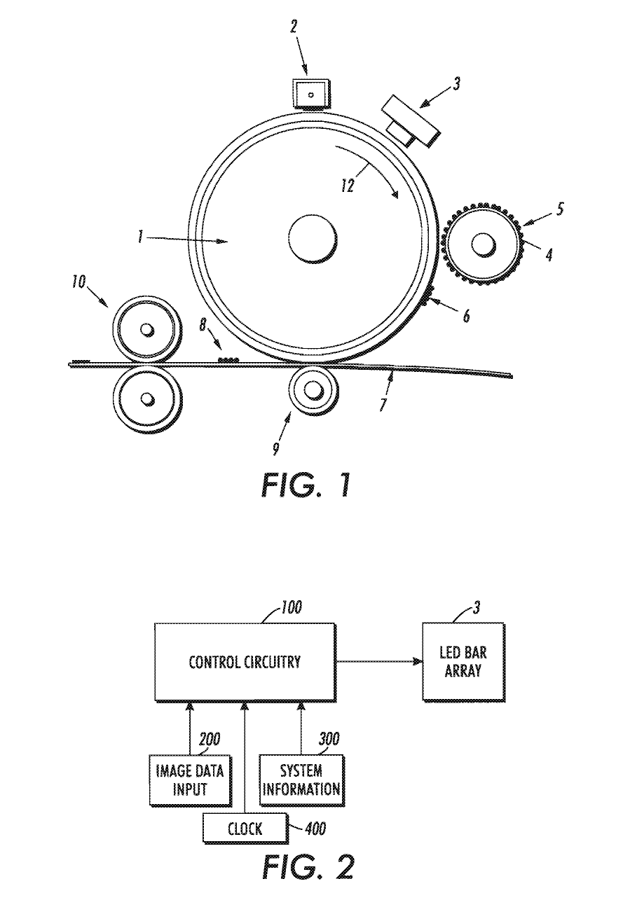

FIG. 1 illustrates an exemplar, photoreceptor unit for developing electrostatic output toner images in an electrostatic image-forming device such as, for example, a xerographic image-forming system. A photoreceptor 1, moving in the direction 12, is electrically charged on its surface by a corotron 2. The charged photoreceptor surface is exposed to light from the LED bar array 3 therein producing a latent image of an original image on the surface of the moving photoreceptor. The photoreceptor surface comes into close contact with donor roll 4 wherein toner particles 5, charged opposite of the photoreceptor surface, are attracted to the photoreceptor surface to form an image with toner particles 6 on the photoreceptor surface.

As shown in FIG. 1, at least one photoreceptor unit 1, such as, for example, a photoreceptor drum shown in FIG. 1, or a photoreceptor belt-type unit, rotates, or otherwise moves, photoreceptor unit 1 in a direction 12. The photoreceptor unit is electrostatically charged on the surface by, for example, an electric charging particle unit such as, for example, a corotron 2. The surface of the photoreceptor unit 1, being so charged, is then exposed to light from a light-emitting device such as, for example, an LED bar array 3. In this manner, an electrostatic latent image corresponding to an input image is produced, or laid down, on the surface of the moving photoreceptor unit 1. The photoreceptor unit 1 and more specifically the charged surface, is brought into proximity, or contact, with one or more devices that provide one or more colors of toner particle to be adhered to the surface of the photoreceptor unit 1, turning the electrostatic latent image into a toner image. An exemplary device by which toner may be imparted to the surface of the photoreceptor unit 1 is a toner donor roll 4 from which toner particles 5 deposited thereon are donated to the charged surface of the photoreceptor unit 1 through electrostatic attraction to the latent image formed on the surface of the photoreceptor unit 1. Such deposited particles 6 form a single- or multi-colored toner image on the electrostatically charged surface of the photoreceptor unit 1 to be further transferred to, for example, a receiving medium 7 on which an output image is to be formed.

As explained above, the latent image formed by deposited toner particles 6 is further deposited as output image particles 8 on the receiving medium 7 that may be biased by, for example, a transfer roll 9. The transferred toner image made up of transferred toner particles 8 is then fixed and/or otherwise fused onto the medium by some sort of fusing device, represented by opposing heated pressure rollers 10 in FIG. 1.

In accordance with exemplary embodiments, the LED bar array 3, which forms the electrostatic latent image, as discussed above, may be activated during a non-image forming cycle to discharge electrostatic charge on the photoconductive surface. This may include residual electrostatic latent image or improperly discharged areas of the photoconductive surface. Using the LED bar array 3 to support either, or both, of these functions may provide benefits in improving erase function by discharging residual electrostatic charge. It may also provide beneficial redundancy for other discharging means, such as, for example, a discharge lamp. It may also provide manufacturing efficiency by using already present components to provide such redundancy, rather than incorporating separate systems to provide these functions.

The light-emitting device, in this case an LED bar array 3, may be controlled in a variety of manners, to provide functions in accordance with this disclosure.

In accordance with exemplary embodiments, the at least one light-emitting device may comprise at least two light-emitting devices such as, for example, multiple LED bar arrays as used in color electrostatic image forming devices. In such embodiments, the at least two light-emitting devices may be controlled in a variety of manners to accomplish various objectives of the disclosure, as discussed further below.

FIG. 2 illustrates a schematic block diagram of an exemplary system for removing residual charges from a photoreceptor unit during a non-image forming cycle. The control circuitry 100 may be operatively connected to the light emitting device such as, for example, the LED array 3. The control circuitry may be configured to selectively activate the LED array 3 to discharge portions of the electrostatic charge on a photoconductive surface during an image forming cycle. The control circuitry may be configured to activate the LED array during a non-image forming cycle to discharge electrostatic charge such as, for example, residual electrostatic charge, on the photoconductive surface.

The control circuitry 100 may support various exemplary methods for removing residual charges from a photoreceptor unit during a non-image forming cycle. The control circuitry 100 may be configured to control the timing and the intensity of activating the light-emitting source. The control circuitry 100 may receive image data input 200. The control circuitry 100 may processes this information and may selectively activate elements (not shown) within the light-emitting device used to discharge portions of electrostatic charge on the photoconductive surface during an image forming cycle. Other relevant system information 300 may be fed to the control circuitry 100 to allow for determination of other necessary processing information such as, for example, movement or rotation of the photoconductive surface to determine processing progress and timing.

Based on information gathered from the image data input 200 and system information 300, as well as a clock 400, the control circuitry 100 may determine the beginning and end of the image forming cycle. As used herein, the term image forming cycle should be understood to mean the time during which the control circuitry 100 is activating the at least one light-emitting device to selectively discharge portions of electrostatic charge on the photoconductive surface in accordance with image data input. The control circuitry may activate the at least one light-emitting device during a non-image forming cycle in a variety of manners.

Exemplary embodiments may include configuring the control circuitry to activate the LED bar array 3 during a non-image forming cycle before the image forming cycle such as, for example, during warm up of the electrostatic image forming device, to discharge residual electrostatic charge on the photoreceptor unit.

Exemplary embodiments may include configuring the control circuitry to activate the LED bar array 3 during a non-image forming cycle after the image forming cycle to discharge residual electrostatic charge on the photoreceptor unit.

Exemplary embodiments may include configuring the control circuitry to activate two or more light emitting devices at different times during a single non-image forming cycle.

Exemplary embodiments may include configuring the control circuitry to activate only one of two or more light emitting devices during a single non-image forming cycle.

Exemplary embodiments may include configuring the control circuitry to routinely activate the at least one light emitting device at a predetermined level during a non-image forming cycle. “Routinely activated” means that there is a set time or stage in the functioning of the electrostatic image forming device such as, for example, during warm-up or after completion of all outstanding image forming cycles. “Predetermined” means that the value is set prior to a particular image input.

Exemplary embodiments may include configuring the control circuitry to routinely activate the at least one light emitting device for a predetermined time period during a non-image forming cycle.

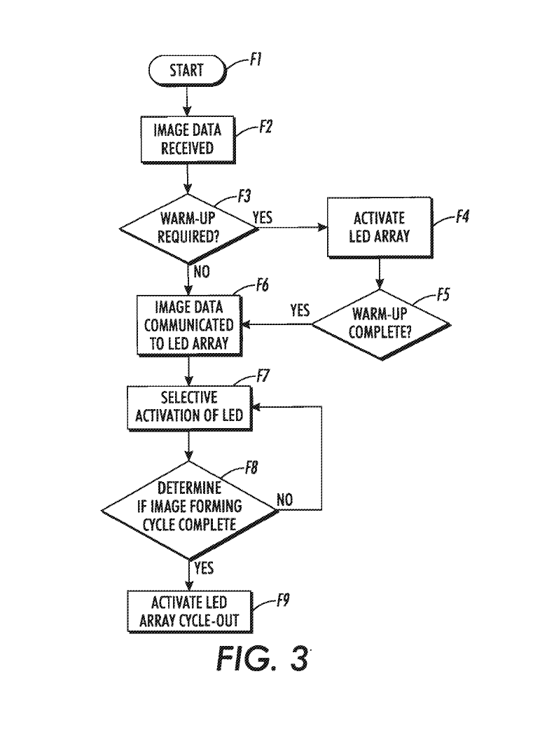

FIG. 3 is a flowchart outlining exemplary methods for removing residual charges from a photoreceptor unit during a non-image forming cycle. Exemplary embodiments include activating the LED bar array 3 during a non-image forming cycle to discharge residual electrostatic charge on the photoreceptor 1.

Exemplary methods may comprise: applying an electrostatic charge to a photoconductive surface; forming a latent image on the photoconductive surface by discharging portions of electrostatic charge on the photoconductive surface by selectively activating at least one light emitting device during a image forming cycle; and activating the at least one light emitting device during a non-imaging forming cycle to discharge electrostatic charge on the photoconductive surface.

As depicted in FIG. 3, exemplary methods may commence during step F1. Image date may be received by the control circuitry during F2. The method continues to F3.

During F3, the control circuitry may determine whether printing can commence such as, for example, whether a “warm-up” cycle is required. If, for example, a “warm-up” cycle, or other preliminary non-image forming cycle, is required, the method may continue to F4. If the determination during F3 is “yes”, the method may continue to F6.

During F4, the at least one light emitting device may be routinely activated at a predetermined level and/or for a defined time period. Such activation of the at least one light emitting device may be considered as immediately prior to an image forming cycle. In this case, “immediately prior” signifies that there are no interceding image forming cycles between the identified non-image forming cycle, in this case a “warm-up” cycle, and image forming cycle. The method may continue with F5.

During F5, the control circuitry may determine if the preliminary non-image forming cycle is complete, in this case, if the “warm-up” cycle is complete. Once this registers “yes” , the method may continue to F6.

During F6, image data may be communicated to the at least one light emitting device. The method may continue to F7.

F7 may constitute the beginning of an image forming cycle. During F7, elements of the at least one light emitting device may be selectively activated in accordance with the image data, thereby discharging portions of a previously applied electrostatic charge on the photoconductive surface. Such discharging may form a latent image on the photoconductive surface. It should be noted that in exemplary embodiments, F7 may be ongoing concurrently with applying electrostatic charge to other portions of the photoconductive surface. The method may continue to F8.

During F8, the control circuitry may determine whether the image forming cycle is complete. If F8 determines “no”, the method may continue with F7 until F8 determines a “yes”. Once F8 determines a “yes”, the method may continue with F9.

During F9, the at least one light emitting device may be activated at a predetermined level and/or for a defined time period to discharge electrostatic charge on the photoconductive surface. This may be considered as, for example, a “cycle-out” cycle. Such activation of the at least one light emitting device may be considered as immediately after an imaging cycle. In this case, “immediately after” signifies that there are no interceding image forming cycles between the identified image forming cycle and non-image forming cycle. It should be noted that, in exemplary embodiments, F9 may be ongoing concurrently with applying electrostatic charge to other portions of the photoconductive surface.

It should be appreciated that functions disclosed in exemplary embodiments may be performed in various orders and/or manners, and the functions may support and/or include multiple light-emitting devices in which the sequence of activating the multiple light-emitting devices may be performed in a variety of methods.

In accordance with exemplary embodiments, the electrostatic charge on the photoconductive surface may be discharged by at least two light emitting devices.

In accordance with exemplary embodiments, the electrostatic charge on the photoconductive surface may be discharged by at least two light emitting devices that are activated at different times during a single non-image forming cycle such as, for example, the described “cycle-out” cycle.

In accordance with exemplary embodiments, the electrostatic charge on the photoconductive surface may be discharged by only one of at least two light emitting devices during a single non-image forming cycle such as, for example, the described “warm-up” cycle.

In accordance with exemplary embodiments, a computer program product may be provided for enabling a computer to control a light emitting device in an electrostatic image forming device to be used as a photoreceptor surface discharger. The product may comprise software instructions that enables the computer to perform predetermined operations, and a computer readable medium bearing the software instructions. The predetermined operations may include: applying an electrostatic charge to a photoconductive surface; forming a latent image on the photoconductive surface by discharging portions of electrostatic charge on the photoconductive surface by selectively activating at least one light emitting device during a image forming cycle; and activating the at least one light emitting device during a non-imaging forming cycle to discharge electrostatic charge on the photoconductive surface.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

Aspects of the disclosure may encompass embodiments in hardware, software, or a combination thereof.

The word “printer” as used herein encompasses any apparatus, such as a digital copier, book making machine, facsimile machine, multi-function machine, etc. which performs a printout putting function for any purpose. Although it might occur in printing apparatus has been described in the specification. The claims can encompass embodiments that print in color or handle color image data.

What is claimed is:

1. A system for discharging an electrostatic charge of a surface of a photoreceptor unit, comprising:
at least one photoreceptor unit comprising a photoconductive surface;
a charging unit that electrostatically charges the photoconductive surface;
at least one light emitting device that is directed to the photoconductive surface; and
control circuitry, operatively connected to the at least one light emitting device, that is configured to:
selectively activate the light emitting device to discharge portions of electrostatic charge on the photoconductive surface during an image forming cycle, and
activate the at least one light emitting device during a non-image forming, cycle to discharge electrostatic charge on the photoconductive surface.

2. The system of claim 1, wherein the at least one light emitting device comprises an LED array.

3. The system of claim 1, wherein the at least one light emitting device comprises at least two light emitting devices.

4. The system of claim 3, wherein the control circuitry is configured to activate the two or more light emitting devices at different times during a single non-image forming cycle.

5. The system of claim 3, wherein the control circuitry is configured to activate only one of the two or more light emitting devices during a single non-image forming cycle.

6. The system of claim 1, wherein the control circuitry is configured to activate the at least one light emitting device during a non-imaging forming cycle that is immediately prior to the image forming cycle.

7. The system of claim 1, wherein the control circuitry is configured to activate the at least one light emitting device during a non-imaging forming cycle that is immediately after the image forming cycle.

8. The system of claim 1, wherein the control circuitry is configured to routinely activate the at least one light emitting device at a predetermined level during the non-image forming cycle.

9. The system of claim 1, wherein the control circuitry is configured to routinely activate the at least one light emitting device for a defined time period during the non-image forming cycle.

10. A printing system comprising the system of claim 1.

11. A Xerographic printing system comprising the system of claim 1.

12. A method for discharging an electrostatic charge of a surface of a photoreceptor unit, comprising:
applying an electrostatic charge to a photoconductive surface;
forming a latent image on the photoconductive surface by discharging portions of electrostatic charge on the photoconductive surface by selectively activating at least one light emitting device during a image forming cycle;
activating the at least one light emitting device during a non-imaging forming cycle to discharge electrostatic charge on the photoconductive surface.

13. The method of claim 12, wherein the electrostatic charge on the photoconductive surface is discharged by a light emitting device comprising an LED array.

14. The method of claim 12, wherein the electrostatic charge on the photoconductive surface is discharged by at least two light emitting devices.

15. The method of claim 14, wherein the electrostatic charge on the photoconductive surface is discharged by at least two light emitting devices that are activated at different times during a single non-image forming cycle.

16. The method of claim 14, wherein the electrostatic charge on the photoconductive surface is discharged by only one of the at least two light emitting devices during a single non-image forming cycle.

17. The method of claim 12, wherein the non-image forming cycle is immediately prior to the image forming cycle.

18. The method of claim 12, wherein the non-imaging forming cycle is immediately after the image forming cycle.

19. The method of claim 12, wherein the at least one light emitting device is routinely activated at a predetermined level during the non-image forming cycle.

20. A computer program product for enabling a computer to control a light emitting device in an electrostatic image forming device to be used as a photoreceptor surface discharger, comprising software instructions that enable the computer to perform predetermined operations and a computer readable medium including the software instructions, the predetermined operations including:
applying an electrostatic charge to a photoconductive surface;
forming a latent image on the photoconductive surface by discharging portions of electrostatic charge on the photoconductive surface by selectively activating at least one light emitting device during a image forming cycle;
activating the at least one light emitting device during a non-imaging forming cycle to discharge electrostatic charge on the photoconductive surface,
whereby the computer causes the light emitting device to discharge the photoconductive surface.
